(19) United States
(12) Patent Application Publication
(10) Pub. No.: US 2025/0124289 A1
(43) Pub. Date: Apr. 17, 2025

(54) Incremental Sparsification of Machine Learning Model

(71) Applicant: Numenta, Inc., Redwood City, CA (US)

(72) Inventor: Lucas Souza, San Francisco, CA (US)

(21) Appl. No.: 18/488,903

(22) Filed: Oct. 17, 2023

(51) Int. Cl. G06N 3/082

(52) U.S. Cl. CPC G06N 3/082

(57) ABSTRACT

Embodiments are related to generating a sparsified machine learning model by incrementally sparsifying a machine learning model followed by training of the sparsified machine learning model. The initial machine learning model may be trained as a dense model that includes a large number of active values in its weight tensors. Multiple iterations of sparsifying weights in the weight tensors followed by training of the sparsified machine learning model are performed to gradually increase the sparsity of the weight tensor while recovering or maintaining the accuracy of the output from the machine learning model.

### FIELD OF THE DISCLOSURE

The present disclosure relates to improving the performance of machine learning models, and more specifically to introducing sparsity to machine learning models to improve the performance of the models in processors.

### BACKGROUND

The utilization of machine learning models, such as artificial neural networks (ANNs) or similar deep learning architectures, encompasses a broad spectrum of technologies. The complexity of these models, as measured by the sheer volume of parameters, is experiencing exponential growth, outpacing improvements in hardware performance. Consequently, many of these models exhibit a substantial parameter count. Training and inference tasks for these models face bottlenecks due to extensive linear tensor operations, including multiplication and convolution. As a result, considerable time and/or resources are often required for both the development (e.g., training) and deployment (e.g., inference) of these machine learning models.

Computing systems that execute machine learning models often involve extensive computing operations including multiplication and accumulation. For example, a convolution neural network (CNN) is a class of machine learning techniques that primarily uses convolution between input data and kernel data, which can be decomposed into multiplication and accumulation operations. Using a general processor, such as a central processing unit (CPU) and its main memory, to instantiate and execute machine learning systems or models of various configurations is relatively easy because such systems or models can be instantiated with mere updates to code. However, general processors' architectures are often fixed and machine learning models without specific structures may not enable execution speed performance gain when the models are run in those general processors.

### SUMMARY

Embodiments relate to sparsifying a trained machine learning model by modifying a select number of sensitivity metric values in a segment of a layer, and then selecting weights across multiple layers for pruning according to the modified sensitivity metric values. The weights of a plurality of layers of the trained machine learning model and first training data used for training the machine learning models are received. A sensitivity metric value for each of the weights in the trained machine learning model is determined. The sensitivity metric value indicates the influence of each of the weights on an output of the machine learning model. For each subset of weights in a layer of the machine learning model, a first predetermined number or percentage of the sensitivity metric values are modified. Across the plurality of layers of the machine learning model, a second predetermined number or percentage of the weights are selected as first weights for pruning by comparing the sensitivity metric values of the weights. The weights corresponding to the modified sensitivity metric values are less likely to be selected as the first weights. Training is then performed on the machine learning model with the first weights pruned to generate a first updated machine learning model with a first sparsity of weights.

In one or more embodiments, a sensitivity metric value for each of weights in the first updated machine learning model is determined. For each subset of weights in a layer of the first updated machine learning model, a second predetermined number or percentage of the sensitivity metric values are modified. Across the plurality of layers of the first updated machine learning model, a third predetermined number or percentage the weights of the first updated machine learning model are selected as second weights for pruning by comparing the sensitivity metric values of the weights of the first updated machine learning model. The weights of the first updated machine learning model corresponding to the modified sensitivity metric values are less likely to be selected for pruning. Training is performed on the first updated machine learning model with the second weights pruned to generate a second updated machine learning model with a second sparsity of weights higher than the first sparsity of weights.

In one or more embodiments, a first mask representing an array with entries corresponding to the weights of the machine learning model is generated. The entries of the first mask corresponding to the first weights to zero are set to zero. The first mask is applied to generate the first updated machine learning model. A second mask representing an array with entries corresponding to the weights of the first updated machine learning model is generated. The entries of the second mask corresponding to the second weights are set to zero. The second mask is applied to the first updated machine learning model for generating the second updated machine learning model.

In one or more embodiments, a first consolidated tensor concatenating the weights in the machine learning model is generated. The sensitivity metric value of each of the weights in the machine learning model is determined by processing the first consolidated tensor. A second consolidated tensor concatenating the weights in the first updated machine learning model is generated. The sensitivity metric value of each of the weights in the first updated machine learning model is determined by processing the second consolidated tensor.

In one or more embodiments, the training of the machine learning model with the selected weights is performed using second training data that is part of the first training data, and the training of the first updated machine learning model is performed using third training data that is part of the first training data.

In one or more embodiments, predetermined rules are applied to select the first predetermined number or percentage of the sensitivity metric values where the predetermined rules indicate that sensitivity metric values of higher values are more likely to be modified relative to sensitivity metric values of lower values. The first predetermined number or percentage of the sensitivity metric values are modified by increasing the first predetermined number or percentage of the sensitivity metric values by a predetermined value.

In one or more embodiments, the predetermined rules are associated with patterns of weights suitable for accelerated processing by a hardware circuit.

In one or more embodiments, the sensitivity metric value is based on at least one of a magnitude of each of the weights and a gradient associated with each of the weights.

In one or more embodiments, the first updated machine learning model is deployed to perform prediction, inference or creation where the first updated machine learning model is faster than the machine learning model.

Embodiments also relate to iteratively performing the sparsification of a trained machine learning model by (a) receiving weights of a plurality of layers of a current machine learning model trained using first training data, (b) determining a sensitivity metric value for each of the weights in the current machine learning model is determined, (c) sparsifying the weights of the machine learning model by selectively zeroing the weights with lowest sensitivity metric values to generate an intermediate machine learning model, (d) training the intermediate machine learning model using second training data to generate an updated machine learning model, (e) determining if the updated machine learning model satisfies a termination condition, (f) responsive to determining that the termination condition is satisfied, setting the updated machine learning model as a sparsified machine learning model; and (g) responsive to determining that the termination condition is not satisfied, setting the updated machine learning model as the current machine learning model and repeating (a) through (g).

In one or more embodiments, (c) sparsifying the weights comprises: (c1) for each subset of weights in a layer of the current machine learning model, selecting a first predetermined number or percentage of weights with highest sensitivity metric values, (c2) increasing sensitivity metric values of the selected weights, (c3) selecting a second predetermined number of percentage weights in the machine learning model with lowest sensitivity metric values as weights to be pruned, and (c4) zeroing the weights to be pruned to generate the intermediate machine learning model.

The features and advantages described in the specification are not all inclusive, and in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

Figure (FIG. 1 is a block diagram of a computing device for executing an application using machine learning models, according to one embodiment.

FIG. 2A is a conceptual diagram illustrating an example architecture of a machine learning model, according to one embodiment.

FIG. 2B is a block diagram illustrating an example general operation of a node in the machine learning model of FIG. 2A, according to an embodiment.

FIGS. 2C through 2F illustrate the concept of sparsity in a machine learning model, according to embodiments.

FIG. 3 is a block diagram illustrating environment for improving the performance of a machine learning model, according to one embodiment.

FIG. 4 is a block diagram of a computing server for improving the performance of a machine learning model, according to one embodiment.

FIG. 5A is a diagram illustrating dense weights in a layer of a machine learning model, according to one embodiment.

FIG. 5B is a diagram illustrating sparse weights in the layer of the machine learning model, according to one embodiment.

FIG. 6 is a conceptual diagram illustrating converting of weights in multiple layers of a machine learning model into a consolidated vector, according to one embodiment.

FIG. 7 is a conceptual diagram illustrating processing of segments in an array of sensitivity metric values, according to one embodiment.

FIGS. 8A and 8B are conceptual diagrams illustrating pruning of weights in layers of a machine learning model, according to one embodiment.

FIG. 9 is a flowchart illustrating the process of sparsifying a machine learning model, according to one embodiment.

### DETAILED DESCRIPTION OF EMBODIMENTS

In the following description of embodiments, numerous specific details are set forth in order to provide more thorough understanding. However, note that the present invention may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left-most digit of each reference number corresponds to the figure in which the reference number is first used.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to the desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. A computer readable medium is a non-transitory medium that does not include propagation signals and transient waves. Furthermore, the computers referred to in the specification may include a single processor or may be architectures employing multiple processor designs for increased computing capability. Various embodiments described may also be implemented as field-programmable gate arrays (FPGAs), which include hardware programmable devices that accept programming commands to execute the processing of input data.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, embodiments are not described with reference to any particular programming language. It will be appreciated that a variety of programming languages may be used to implement the teachings as described herein, and any references below to specific languages are provided for disclosure of enablement and best mode of the embodiments.

In addition, the language used in the specification has been principally selected for readability and instructional purposes, and may not have been selected to delineate or circumscribe the inventive subject matter. Accordingly, the disclosure set forth herein is intended to be illustrative, but not limiting, of the scope, which is set forth in the claims.

Embodiments are related to incrementally increasing sparsity of a machine learning model and training the sparsified machine learning model. The initial machine learning model may be trained as a dense model that includes a large number of active values in its weight tensors. Multiple iterations of spardsifying weights in the weight tensors followed by training of the sparsified machine learning model may be performed to gradually increase the sparsity of the weight tensor while recovering or maintaining the accuracy of the output from the machine learning model. In this way, a sparsifed machine learning model with sparsified weight tensors with an increased speed using reduced computing resources while maintaining the accuracy of the result may be obtained.

FIG. 1 is a block diagram of a computing device 100 for executing an applications 130 using machine learning models 140, according to one embodiment. The computing device 100 may be a server computer, a personal computer, a portable electronic device, a wearable electronic device (e.g., a smartwatch), an IoT device (e.g., a sensor), smart/connected appliance (e.g., a refrigerator), dongle, a device in edge computing, a device with limited processing power, etc. The computing device 100 may include, among other components, a central processing unit (CPU) 102, an artificial intelligence (AI) accelerator 104 for performing tensor operations, a graphical processing unit (GPU) 106, system memory 108, a storage unit 110, an input interface 114, an output interface 116, a network interface 118, and a bus 120 connecting these components. In various embodiments, computing device 100 may include additional, fewer or different components.

While some of the components in this disclosure may at times be described in a singular form while other components may be described in a plural form, various components described in any system may include one or more copies of the components. For example, a computing device 100 may include more than one processor such as CPU 102, AI accelerator 104, and GPU 106, but the disclosure may refer the processors to as “a processor” or “the processor.” Also, a processor may include multiple cores.

CPU 102 may be a general-purpose processor using any appropriate architecture. CPU 102 retrieves and executes computer code including instructions, when executed, may cause CPU 102 or another processor, individually or in combination, to perform certain actions or processes that are described in this disclosure. Instructions can be any directions, commands, or orders that may be stored in different forms, such as equipment-readable instructions, programming instructions including source code, and other communication signals and orders. Instructions may be used in a general sense and are not limited to machine-readable codes. CPU 102 may be used to compile the instructions and also determine which processors may be used to perform certain tasks based on the commands in the instructions. For example, certain machine learning computations may be more efficiently performed using AI accelerator 104 while other parallel computations may be better to be processed using GPU 106.

AI accelerator 104 may be a processor that is efficient at performing certain machine learning operations such as tensor multiplications, convolutions, tensor dot products, etc. In various embodiments, accelerator 104 may have different hardware architectures. For example, in one embodiment, accelerator 104 may take the form of field-programmable gate arrays (FPGAs). In another embodiment, accelerator 104 may take the form of application-specific integrated circuits (ASICs), which may include circuits along or circuits in combination with firmware. In some embodiments, a computing device 100 may not have an accelerator 104. Instead, the computing device 100 relies on the CPU 102 or the GPU 106 to run machine learning models.

GPU 106 may be a processor that includes highly parallel structures that are more efficient than CPU 102 at processing large blocks of data in parallel. GPU 106 may be used to process graphical data and accelerate certain graphical operations. In some cases, owing to its parallel nature, GPU 106 may also be used to process a large number of machine learning operations in parallel. GPU 106 is often efficient at performing the same type of workload many times in rapid succession.

While, in FIG. 1, the CPU 102, accelerator 104, and GPU 106 are illustrated as separated components, in various embodiments the structure of one processor may be embedded in another processor. For example, one or more examples of the circuitry of accelerator 104 disclosed in different figures of this disclosure may be embedded in a CPU 102. The processors may also be included in a single chip such as in a system-on-a-chip (SoC) implementation. In various embodiments, computing device 100 may also include additional processors for various specific purposes. In this disclosure, the various processors may be collectively referred to as “processors” or “a processor.”

System memory 108 includes circuitry for storing instructions that are executed by a processor and for storing data processed by the processor. System memory 180 may take the form of any type of memory structure including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. System memory 108 usually takes the form of volatile memory.

Storage unit 110 may be a persistent storage for storing data and software applications in a non-volatile manner. Storage unit 110 may take the form of read-only memory (ROM), hard drive, flash memory, or another type of non-volatile memory device. Storage unit 110 stores the operating system of the computing device 100, various software applications 130 and machine learning models 140. Storage unit 110 may store computer code that includes instructions that, when executed, cause a processor to perform one or more processes described in this disclosure.

Applications 130 may be any suitable software applications that operate at the computing device 100. An application 130 may be in communication with other devices via network interface 118. Applications 130 may be of different types. In one case, an application 130 may be a web application, such as an application that runs on JavaScript. In another case, an application 130 may be a mobile application. For example, the mobile application may run on Swift for iOS and other APPLE operating systems or on Java or another suitable language for ANDROID systems. In yet another case, an application 130 may be a software program that operates on a desktop operating system such as LINUX, MICROSOFT WINDOWS, MAC OS, or CHROME OS. In yet another case, an application 130 may be a built-in application in an IoT device. An application 130 may include a graphical user interface (GUI) that visually renders data and information. An application 130 may include tools for training machine leaning models 140 and/or perform inference using the trained machine learning models 140.

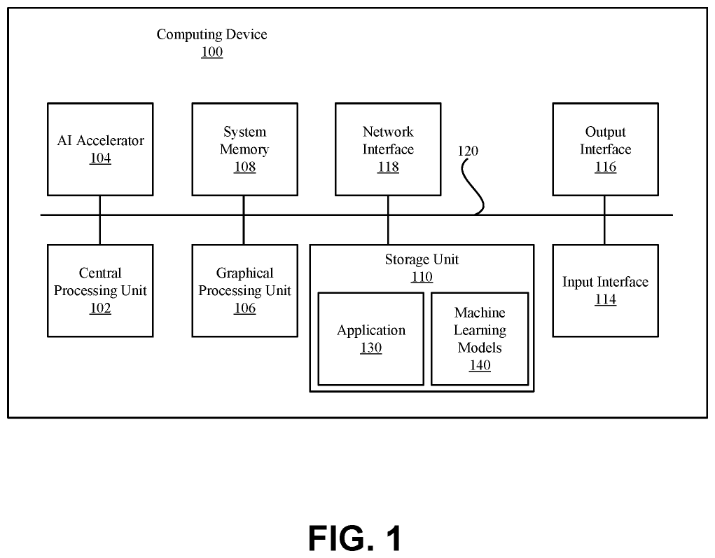

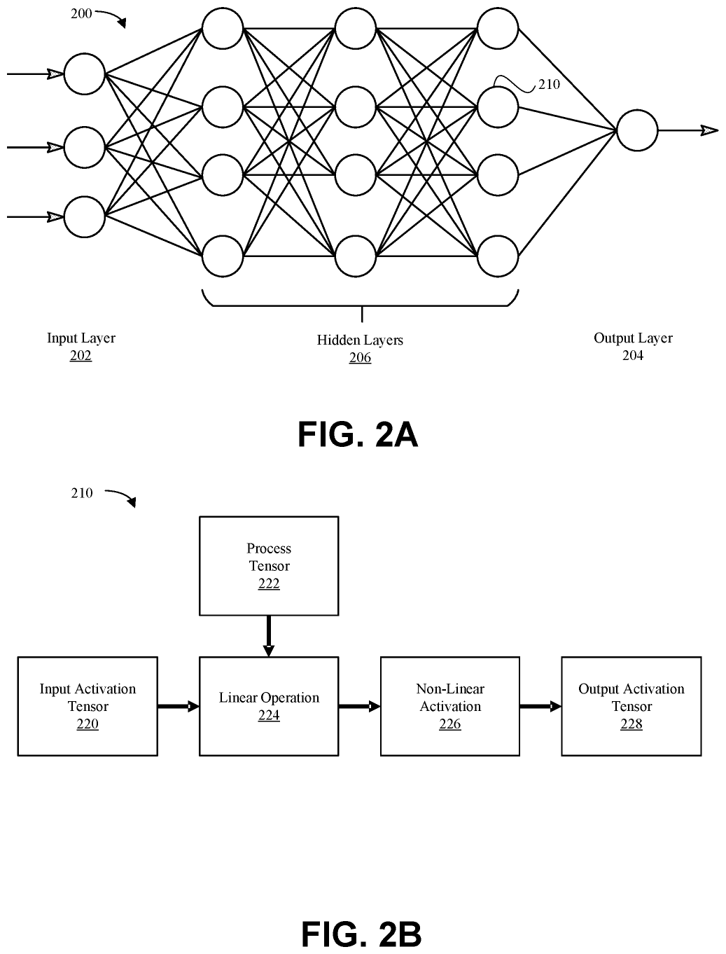

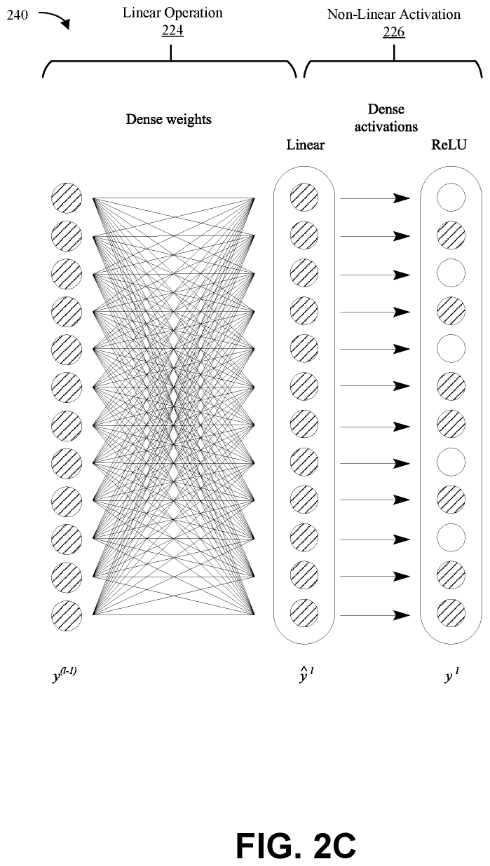

Machine learning models 140 may include different types of algorithms for making inferences based on the training of the models. Examples of machine learning models 140 include regression models, random forest models, support vector machines (SVMs) such as kernel SVMs, and artificial neural networks (ANNs) such as convolutional network networks (CNNs), recurrent network networks (RNNs), autoencoders, long short term memory (LSTM), reinforcement learning (RL) models, transformers, conformers, and spiking neural networks (SNNs). Some of the machine learning models may include a sparse network structure whose detail will be further discussed with reference to FIG. 2B through 2D. A machine learning model 140 may be an independent model that is run by a processor. A machine learning model 140 may also be part of a software application 130. Machine learning models 140 may perform various tasks.

By way of example, a machine learning model 140 may receive sensed inputs representing images, videos, audio signals, sensor signals, data related to network traffic, financial transaction data, communication signals (e.g., emails, text messages and instant messages), documents, insurance records, biometric information, parameters for manufacturing process (e.g., semiconductor fabrication parameters), inventory patterns, energy or power usage patterns, data representing genes, results of scientific experiments or parameters associated with the operation of a machine (e.g., vehicle operation) and medical treatment data. The machine learning model 140 may process such inputs and produce an output representing, among others, identification of objects shown in an image, identification of recognized gestures, classification of digital images as pornographic or non-pornographic, identification of email messages as unsolicited bulk email (‘spam’) or legitimate email (‘non-spam’), prediction of a trend in financial market, prediction of failures in a large-scale power system, identification of a speaker in an audio recording, classification of loan applicants as good or bad credit risks, identification of network traffic as malicious or benign, identity of a person appearing in the image, processed natural language processing, weather forecast results, patterns of a person's behavior, control signals for machines (e.g., automatic vehicle navigation), gene expression and protein interactions, analytic information on access to resources on a network, parameters for optimizing a manufacturing process, predicted inventory, predicted energy usage in a building or facility, web analytics (e.g., predicting which link or advertisement that users are likely to click), identification of anomalous patterns in insurance records, prediction on results of experiments, indication of illness that a person is likely to experience, selection of contents that may be of interest to a user, indication on prediction of a person's behavior (e.g., ticket purchase, no-show behavior), prediction on election, prediction/detection of adverse events, a string of texts in the image, indication representing topic in text, a summary of text or prediction on reaction to medical treatments, and generated contents (e.g., texts, images and speeches). The underlying representation (e.g., photo, audio etc.) can be stored in system memory 108 and/or storage unit 110.

Input interface 114 receives data from external sources such as sensor data or action information. Output interface 116 is a component for providing the result of computations in various forms (e.g., image or audio signals). Computing device 100 may include various types of input or output interfaces, such as displays, keyboards, cameras, microphones, speakers, antennas, fingerprint sensors, touch sensors, and other measurement sensors. Some input interface 114 may directly work with a machine learning model 140 to perform various functions. For example, a sensor may use a machine learning model 140 to infer interpretations of measurements. Output interface 116 may be in communication with humans, robotic agents or other computing devices.

The network interface 118 enables the computing device 100 to communicate with other computing devices via a network. The networks may include, but are not limited to, Local Area Networks (LANs) (e.g., an Ethernet or corporate network) and Wide Area Networks (WANs). When multiple nodes or components of a single node of a machine learning model 140 is embodied in multiple computing devices, information associated with various processes in the machine learning model 140, such as temporal sequencing, spatial pooling and management of nodes may be communicated between computing devices via the network interface 118.

FIG. 2A is a conceptual diagram illustrating an example architecture of a machine learning model 200, according to an embodiment. The illustrated machine learning model 200 shows a generic structure of a neural network. Machine learning model 200 may represent different types of machine learning models, such as regression models, decision trees, decision trees, support vector machines (SVMs), regression, Bayesian networks, genetic algorithms, and neural networks, including convolutional network networks (CNNs), recurrent network networks (RNNs), autoencoders, long short term memory (LSTM), transformers and conformers. In various embodiments, customized changes may be made to this general structure. Machine learning model 200 may also be a hierarchical temporal memory system as described, for example, in U.S. Patent Application Publication No. 2020/0097857, published on May 26, 2020, which is incorporated by reference herein in its entirety.

Using a neural network as an example, a machine learning model 200 may include an input layer 202, an output layer 204 and one or more hidden layers 206. Input layer 202 is the first layer of machine learning model 200. Input layer 202 receives input data, such as image data, speech data, text, etc. Output layer 204 is the last layer of machine learning model 200. Output layer 204 may generate one or more inferences in the form of classifications or probabilities. Machine learning model 200 may include any number of hidden layers 206. Hidden layers 206 are intermediate layers in machine learning model 200 that perform various operations. Machine learning model 200 may include additional or fewer layers than the example shown in FIG. 2A. Each layer may include one or more nodes 210. The number of nodes in each layer in the machine learning model 200 shown in FIG. 2A is an example only. A node 210 may be associated with certain weights and activation functions. In various embodiments, the nodes 210 in machine learning model 200 may be fully connected or partially connected.

Each node 210 in machine learning model 200 may be associated with different operations. For example, in a simple form, machine learning model 200 may be a vanilla neural network whose nodes are each associated with a set of linear weight coefficients and an activation function. In another embodiment, machine learning model 200 may be an example convolutional neural network (CNN). In this example CNN, nodes 210 in one layer may be associated with convolution operations with kernels as weights that are adjustable in the training process. Nodes 210 in another layer may be associated with spatial pooling operations. In yet other embodiments, machine learning model 200 may be a recurrent neural network (RNN), transformers or conformers whose nodes may be associated with more complicated structures such as loops and gates. In a machine learning model 200, each node may represent a different structure and have different weight values and a different activation function.

FIG. 2B is a block diagram illustrating an example general operation of a node 210 in machine learning model 200, according to an embodiment. A node 210 may receive an input activation tensor 220, which can be an N-dimensional tensor, where N can be greater than or equal to one. Input activation tensor 220 may be the input data of machine learning model 200 if node 210 is in the input layer 202. Input activation tensor 220 may also be the output of another node in the preceding layer. Node 210 may apply a weight tensor 222 to input activation tensor 220 in a linear operation 224, such as addition, scaling, biasing, tensor multiplication, and convolution in the case of a CNN. The result of linear operation 224 may be processed by a non-linear activation 226 such as a step function, a sigmoid function, a hyperbolic tangent function (tanh), rectified linear unit functions (ReLU), or a sparsity activation such as a K-winner take all technique that will be discussed below. The result of the activation is an output activation tensor 228 that is sent to a subsequent connected node that is in the next layer of machine learning model 200. The subsequent node uses output activation tensor 228 as the input activation tensor 220. Here, the weight tensor 222 may be a name for a tensor that includes one or more parameters of the machine learning model 200 and the values in the weight tensor 222 often include weight values in a machine learning model but are not limited to weights. A weight tensor throughout this disclosure may also be referred to as a weight tensor.

In various embodiments, a wide variety of machine learning techniques may be used in training machine learning model 200. Machine learning model 200 may be associated with an objective function (also commonly referred to as a loss function), which generates a metric value that describes the objective goal of the training process. The training may intend to reduce the error rate of the model in generating predictions. In such a case, the objective function may monitor the error rate of machine learning model 200. For example, in object recognition (e.g., object detection and classification), the objective function of machine learning model 200 may be the training error rate in classifying objects in a training set. Other forms of objective functions may also be used. In various embodiments, the error rate may be measured as cross-entropy loss, L1 loss (e.g., the sum of absolute differences between the predicted values and the actual value), L2 loss (e.g., the sum of squared distances) or their combinations.

The weights and coefficients in activation functions of neural network may be adjusted by training and also be constrained by sparsity and structural requirements. Sparsity will be further discussed with reference to FIGS. 2C through 2F. Training of machine learning model 200 may include forward propagation and backpropagation. In forward propagation, machine learning model 200 performs the computation in the forward direction based on outputs of a preceding layer. The operation of a node 210 may be defined by one or more functions, such as linear operation 224 and non-linear activation 226. The functions that define the operation of a node 210 may include various computation operations such as convolution of data with one or more kernels, pooling, recurrent loop in RNN, various gates in LSTM, etc. The functions may also include an activation function that adjusts the output of the node.

Each of the functions in machine learning model 200 may be associated with different weights (e.g., coefficients and kernel coefficients) that are adjustable during training. After an input is provided to machine learning model 200 and passes through machine learning model 200 in the forward direction, the results may be compared to the training labels or other values in the training set to determine the neural network's performance. The process of prediction may be repeated for other samples in the training sets to compute the overall value of the objective function in a particular training round. In turn, machine learning model 200 performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., machine learning model 200 has converged) or after a predetermined number of rounds for a particular set of training samples. The trained machine learning model 200 can be used for making inferences or another suitable task for which the model is trained.

FIGS. 2C through 2F illustrate the concept of sparsity in a machine learning model 200, according to various embodiments. Each of FIGS. 2C, 2D, 2E, and 2F show the operation within a node 210 with different degrees of sparsity and is a graphical illustration of the flowchart shown in FIG. 2B. A circle in FIGS. 2C, 2D, 2E, and 2F represents a value in a tensor. In a machine learning model 200 with L hidden layers, the notation y^{l} denotes output activation tensor 228 from layer/and y^{l-1} denotes the output activation tensor 228 in the preceding layer l−1 or the input activation tensor 220 of layer l. W^{l} and u^{l} represent respectively the weight tensor 222 and biases for each node. In a neural network node 210 that has a dense weight tensor W^{l}, the feed-forward outputs are calculated as follow:

$${\hat{y}}^{l} = {W}^{l} \cdot {y}^{l - 1} + {u}^{l} \qquad Equation 1$$

$${y}^{l} = f ( {\hat{y}}^{l} ) \qquad Equation 2$$

where f is any activation function, such as tanh or ReLU and ŷ^{l} is the output of the linear operation before an activation function is applied.

The above relationship may be conceptually represented as a block diagram as illustrated in FIG. 2B. Graphically, a dense node with dense weights and a dense activation function such as tanh or ReLU is illustrated in FIG. 2C. In FIG. 2C, the result ŷ^{l} after the linear operation is dense with most of the values being non-zero. The active values (e.g., non-zero values) are represented by the shaded circles. The activation function also results in a dense output y^{l} in which a majority of the values are still active, which are also represented by the shaded circles.

Here, an active value may refer to a value whose mathematical operations are to be included in order to perform the overall computation. For example, in the context of matrix multiplication, convolution, or dot product, an active value may be a non-zero value because the mathematical operations, such as addition and multiplication, of the non-zero value are to be included in order to obtain the correct result of the matrix multiplication, convolution, or dot product. An inactive value may refer to a value whose mathematical operation may be skipped. For example, in the context of matrix multiplication, convolution, or dot product, an inactive value is zero because the mathematical operation involving zero, such as addition and multiplication, may be skipped without affecting the final result. A weight tensor is dense if the percentage of active values in the tensor exceeds a threshold. Likewise, an activation is dense if the activation function will result in a number of output values in the output activation tensor y^{l} being dense and the percentage of the active values exceeding a threshold. The disclosure is primarily related to sparsifying dense weight tensors. Using ReLU as an example, ReLU sets values that are lower than a level (e.g., 0) as 0 and allows values that are greater than the level to retain the values. Hence, it is expected that ReLU will generate about half active values if the values in the intermediate tensor ŷ^{l} are roughly equally distributed around the level. A tensor output that has about half of the values being non-zero is often considered as dense. In FIG. 2C, since the weight tensor is dense and the activation layer will also generate a dense value, the node 240 can be considered as a weight-dense and activation-dense node 240, or simply referred to as dense-dense node 240.

The degree of sparsity for a tensor to be considered sparse may vary, depending on embodiments. In one embodiment, the number of active values in a tensor is fewer than 50% to be considered a sparse tensor. In one embodiment, the number of active values in a tensor is fewer than 40% to be considered a sparse tensor. In one embodiment, the number of active values in a tensor is fewer than 30% to be considered a sparse tensor. In one embodiment, the number of active values in a tensor is fewer than 20% to be considered a sparse tensor. The number of active values in a tensor is fewer than 15% to be considered a sparse tensor. The number of active values in a tensor is fewer than 10% to be considered a sparse tensor. The number of active values in a tensor is fewer than 5% to be considered a sparse tensor. The number of active values in a tensor is fewer than 4% to be considered a sparse tensor. The number of active values in a tensor is fewer than 3% to be considered a sparse tensor. The number of active values in a tensor is fewer than 3% to be considered a sparse tensor. The number of active values in a tensor is fewer than 2% to be considered a sparse tensor. The number of active values in a tensor is fewer than 1% to be considered a sparse tensor. The number of active values in a tensor is fewer than 0.8% to be considered a sparse tensor. The number of active values in a tensor is fewer than 0.5% to be considered a sparse tensor. The number of active values in a tensor is fewer than 0.2% to be considered a sparse tensor. The number of active values in a tensor is fewer than 0.1% to be considered a sparse tensor. The number of active values in a tensor is fewer than 0.01% to be considered a sparse tensor.

FIG. 2D is a conceptual diagram that illustrates a sparse-dense node 250, according to an embodiment. Compared to the node 240 in FIG. 2C, node 250 has sparse weights that are illustrated by having fewer connected lines. Despite being illustrated as a dense tensor, the input y^{l-1} can be a dense tensor or a sparse tensor, depending on the previous node's sparsity. The weights of this node 240 are sparse, meaning that there are a large number of inactive values (e.g., zeros) in the weight tensor. A sparse weight tensor may be achieved by imposing a constraint on node 240 to limit the maximum number of active values in the weight tensor. After the linear operation, the intermediate tensor ŷ^{l} is likely to be dense because the linear operation, such as tensor multiplication or convolution, likely spreads the number of active values in the tensor. After the linear operation, the non-linear activation 226 step is the same as the node 240 in FIG. 2C. For example, the ReLU activation function will get around half of the values as zeros. Overall, the output tensor y^{l} is still a dense tensor since about half of the values are dense. In this example, node 250 may be referred to as a weight-sparse and activation-dense node or simply sparse-dense node.

FIG. 2E is a conceptual diagram that illustrates a sparse-sparse node 260, according to an embodiment. Compared to node 250 in FIG. 2D, node 260 also has sparse weights, but it also has a sparse activation function that generates a sparse output. The input y^{l-1} can be a dense tensor or a sparse tensor, depending on the previous node's sparsity. In this example, the input y^{l-1} is illustrated as a sparse tensor. Even though the weights of this node 260 are sparse, after the linear operation, the intermediate tensor ŷ^{l} is likely to be dense because the linear operation likely spreads the number of non-zero values in the tensor. After the linear operation, a sparse activation function called K-winner activation is used instead of a dense activation such as ReLU activation function. K-winner activation selects the top K values in the intermediate tensor ŷ^{l} and force all other values, non-zero or not, to zeros. K may be a constraint set to maintain the sparsity of node 260 and may be set as a percentage of the total number of values in a tensor. For example, K may be 30%, 20%, 15%, 10%, 5%, etc., depending on the selection. The output tensor y^{l} is a sparse tensor after the K-winner activation function that restrains the number of active values in the tensor. In this example, node 260 may be referred to as a weight-sparse and activation-sparse node or simply sparse-sparse node. Using a sparse activation function in a node may be referred to as activation sparsity. FIG. 2F is a conceptual diagram that illustrates a dense-sparse node 270, according to an embodiment. Node 270 has dense weights, but it has a sparse activation function that generates a sparse output.

Machine learning model 200 with one or more nodes that have the sparse-dense or sparse-sparse structure may be referred to as a sparse neural network. A sparse neural network may be a hierarchical temporal memory system. In various embodiments, while a sparse neural network may include a large number of sparse nodes, the sparse neural network may also include some dense nodes. Also, a sparse node may be a sparse-sparse node 260 or a sparse-dense node 250. In some embodiments, a node may also be with either weight sparsity or activation sparsity.

A sparse neural network often has improved performance in terms of speed in training and inference because the large number of inactive values in the network allows the network to skip many mathematical operations. For example, many common operations in neural networks, such as convolution and tensor multiplication, may be converted to dot products. Oftentimes a processor uses dot products to compute those operations in neural networks. Zeros in the tensors will significantly simplify the number of multiplications and additions associated with a dot product. In many cases, sparse neural networks may model the structure of a human brain, which appears to also rely on a large degree of sparsity. Those sparse neural networks often not only have improved speed compared to dense neural networks but also increase inference accuracy particularly in the cases of noisy environments. For example, sparse neural networks reduce the number of parameters necessary to achieve an equivalent result accuracy, leading to savings in computational infrastructure, execution time, latency, power and therefore costs. They also exhibit increased robustness to noise in real-world situations. In Edge and IoT applications, a sparse network may fit on a limited deployment platform where an equivalent dense network would not.

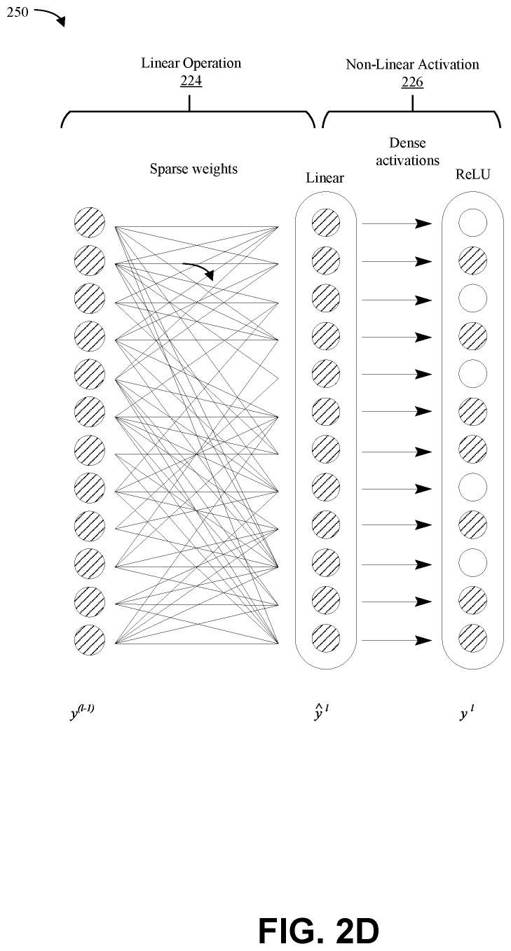

FIG. 3 is a block diagram illustrating environment 300 for improving the performance of a machine learning model, according to one embodiment. By way of example, the system environment 300 includes a computing server 310, a client device 320, a data store 330, and an end user device 340. The entities and components in the system environment 300 communicate with each other through the network 350. In various embodiments, the system environment 300 may include different, fewer, or additional components. The components in the system environment 300 may each correspond to a separate and independent entity or may be controlled by the same entity. For example, in one embodiment, the computing server 310 may control the data store 330.

While each of the components in the system environment 300 is often described in disclosure in a singular form, the system environment 300 may include one or more of each of the components. For example, there can be multiple end user devices 340. Likewise, the computing server 310 may provide service for multiple clients, each of whom has one or more client devices 320. While a component is described in a singular form in this disclosure, in various embodiments, the component may have multiple instances. Hence, in the system environment 300, there can be one or more of each of the components.

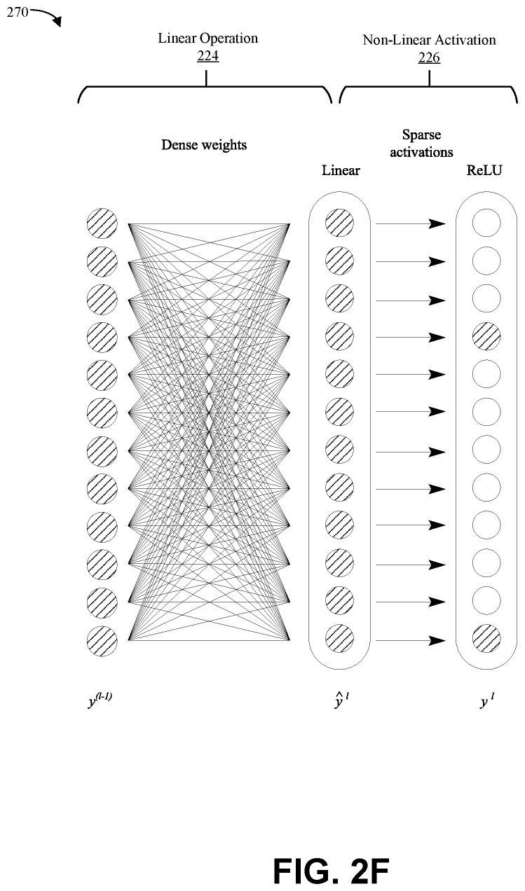

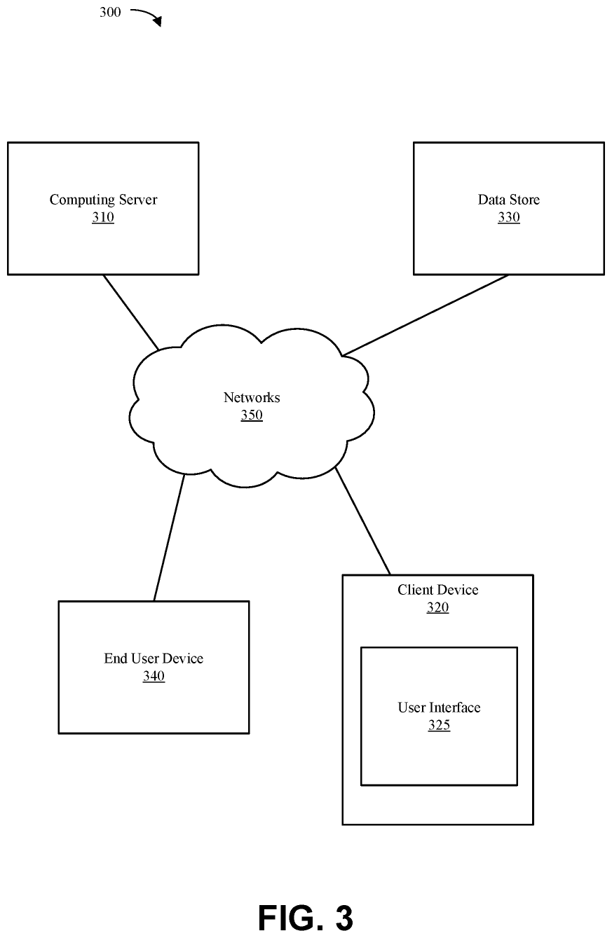

A computing server 310 may provide various services related to improving the performance of machine learning models and training machine learning models for different clients. For example, the computing server 310 may receive a machine learning model from a client. The machine learning model may already be trained to achieve a predetermined degree of performance such as certain training accuracy. The computing server 310 may improve the performance of the model by increasing the sparsity of the model so that the model runs faster than the original version of the machine learning model (e.g., a model provided by the client). The sparsifying of the model may be performed by using methods described below with reference to FIG. 5A through FIG. 9. In various embodiments, a sparse model may refer to a model that has one or more tensors that are sparse (e.g., weight tensor). The entire model may also be relatively sparse but may contain one or more dense nodes, dense tensors, or dense layers.

The computing server 310 may evaluate the performance of the improved machine learning model by determining one or more performance metrics of the machine learning model. For example, a client may provide a machine learning model that has 90% accuracy. The computing server 310 may introduce sparsity to the model in certain manners that will be discussed in further detail below. The improved model may have N times speed up while maintaining a similar level of accuracy or only sacrificing some acceptable level of accuracy. In turn, the computing server 310 may transmit the improved model back to the client.

In some embodiments, the computing server 310 may generate multiple sparse machine learning models derived from client's model provided for the client's selection. In some embodiments, the computing server 310 may generate a set of machine learning models. Each of the models may have at least one weight tensor that is sparsified. The computing server 310 may provide values of the performance metric associated with machine learning models in the set for the client's selection of one of the machine learning models as the final model to be used. For example, a set of N (e.g., 10) models may be generated by the computing server 310, each with increasing sparsity so that the speed performance is increased. Generally but not necessarily, the increase in sparsity reduces the accuracy. Hence, the set of models may be on a sliding scale in terms of speed performance with the tradeoff of accuracy for the client to select which machine learning model is to be deployed for use.

In some embodiments, the computing server 310 may also perform partial or full training of a machine learning model for the client. For example, the computing server 310 may receive information regarding the structure of the machine learning model. The structural information of the machine learning model may include the number of layers, the number of nodes in each layer, the types of nodes (e.g., convolution, pooling, recurrent, gated, etc.), the number of parameters, and other hyperparameters. The computing server 310 may also receive training samples from the client. The computing server 310 may further receive one or more performance goals (e.g., minimum accuracy, speed, average and peak RAM usage, power consumption, the overall size of the model) and sparsity constraints associated with the training of the machine learning model. The computing server 310 may perform partial or full training on behalf of the client. In the training, the computing server 310 may search under the sparsity constraints for sparsity patterns that achieve the performance goals specified by the client and generate a sparse machine learning model.

In some embodiments, the improvement in speed performance by introducing sparsity to the machine learning model may be specific to one or more types of processors (e.g., CPU with certain architectures, GPU with certain architectures). In some embodiments, the improvement in speed may be universal to most processors but are particularly good for certain processor architectures.

A client device 320 is a combination of hardware, software and firmware controlled by a client of the computing server 310. The client device 320 may train a machine learning model and provide the machine learning model to the computing server 310 for introducing sparsity to the model. In some cases, the client device may also update training samples to the data store 330 and delegate the computing server 310 to train a machine learning model. In some embodiments, a machine learning model may be stored as an object such as a PYTHON object that includes parameters that are specified by common machine learning libraries such as TENSORFLOW, PYTORCH and KERAS. The client may initially define the structures and hyperparameter ranges of the machine learning model. The model may then be uploaded to the computing server 310 for sparsity introduction and training.

A client device 320 may include a user interface 325 that is provided and operated by the computing server 310. The user interface 325 may take the form of a software application interface. The computing server 310 may provide a software system for the client to upload a machine learning model, specify training goals and constraints, review sparse models provided by the computing server 310, and select the final model to be used. The user interface 325 may receive a machine learning model and at least one performance goal of the machine learning model. The machine learning model may include a tensor that includes a number of active values that are determined by training of the machine learning model performed by the client. The performance goal may be defined by a performance metric such as in the form of a threshold. In some embodiments, the computing server 310 may provide a set of machine learning models. The user interface 325 may provide a table to compare one or more performance metrics of those models and allow the client to select the final model.

The user interface 325 may take different forms and may be the interface of a software application. The application may be a cloud-based SaaS or a software application that can be downloaded in an application store (e.g., APPLE APP STORE, ANDROID STORE). The user interface 325 may be a graphical user interface (GUI) of a front-end software application that can be installed, run, and/or displayed at a client device 320. The user interface 325 also may take the form of a webpage interface of the computing server 310 to allow a client to manage various machine learning models. In some embodiments, the user interface 325 may not include graphical elements but may provide other ways to communicate with the computing server 310, such as through an application programing interface (API).

The data store 330 includes one or more storage units such as memory that takes the form of non-transitory and non-volatile computer storage medium to store various data. The computer-readable storage medium is a medium that does not include a transitory medium such as a propagating signal or a carrier wave. The data store 330 may be used by the computing server 310 to store data, such as the machine learning models and training samples uploaded by a client device 320 and sparse models generated by the computing server 310. In some embodiments, the data store 330 may take the form of a cloud storage server. Example cloud storage service providers may include AMAZON AWS, DROPBOX, RACKSPACE CLOUD FILES, AZURE BLOB STORAGE, GOOGLE CLOUD STORAGE, etc. In other embodiments, instead of a cloud storage server, the data store 330 may take the form of a storage device that is controlled and connected to the computing server 310. For example, the data store 330 may take the form of memory (e.g., hard drives, flash memory, discs, ROMs, etc.) used by the computing server 310 such as storage devices in a storage server room that is operated by the computing server 310.

An end user device 340 may also be referred to as a user device 340. An end user device 340 may run machine learning models, such as the sparse models, provided by a client of the computing server 310. In some embodiments, the end user may be the customer of the client (who provides the machine learning model) of the computing server 310 (which introduces sparsity to the machine learning model). The end user device 340 may be any computing device. Examples of end user devices 340 include personal computers (PC), desktop computers, laptop computers, tablet computers, smartphones, wearable electronic devices such as smartwatches, or any other suitable electronic devices. In some embodiments, an end user device 340 may have the structure of the computing device 100 described in FIG. 1. In some embodiments, an end user device 340 may have a structure similar to the computing device 100 but without an accelerator 104. The end user device 340 may run one or more machine learning models using the CPU 102 or the GPU 106. The computing server 310 may generate a sparse machine learning model that improves the performance of the end user device 340 using CPU 102 or GPU 106 to run the model. In some embodiments, the end user device 340 may take the form of a device that has limited computing capacity such as a device with a lower performance processor or an Internet-of-Thing (IoT) device that has a low power processor. Sparse models may be compatible for use with these devices and may improve the performance of operations on these devices.

The communications among the computing server 310, the client device 320, the user interface 325, the data store 330, and the end user device 340 may be transmitted via a network 350, for example, via the Internet. In one embodiment, the network 350 uses standard communications technologies and/or protocols. Thus, the network 350 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 350 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 350 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 350 also includes links and packet switching networks such as the Internet.

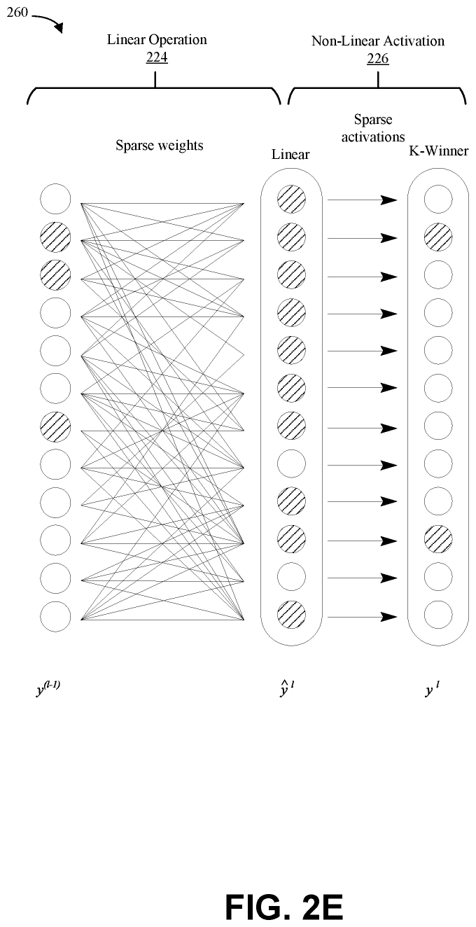

FIG. 4 is a block diagram of the computing server 310 for improving the performance of a machine learning model, according to one embodiment. The computing server 310 may include, among other components, a central processing unit (CPU) 402, an AI accelerator 404, output interface 416, memory 410, network interface 418, and a bus 420 connecting these components. The CPU 402, the AI accelerator 404, the output interface 416, the network interface 419, and the bus 420 are substantially the same as the central processing unit 102, the AI accelerator 104, the output interface 116, the network interface 118 and the bus 120 of computing device 100 illustrated in FIG. 1, and therefore, their detailed descriptions are omitted herein for the sake of brevity.

The memory 410 is a non-transitory storage medium that stores software modules for execution by the CPU 402 and/or the AI accelerator 404. The memory 410 may be embodied as a volatile memory, a non-volatile persistent memory or a combination thereof. The memory 410 may take the form of for example, dynamic random access memory (DRAM), synchronous DRAM (SDRAM), double data rate (DDR, DDR2, DDR3, etc.) RAMBUS DRAM (RDRAM), static RAM (SRAM), ROM, hard drive, flash memory, or any combinations thereof. The memory 410 may store, among other software modules, network sparsifier 430, machine learning models 450, training data 454 for performing training on the machine learning models 450 and temporary store 460.

The machine learning models 450 stored in the memory 410 may include, among other models, original models that are to be processed by the network sparsifier 430, intermediate models that are partially processed by the network sparsifier 430, and finalized models. The original models may be provided by the client and may be dense (e.g., non-sparse) models where at least the weigh tensors are dense. The intermediate models are models that are fully or partially sparsified relative to the original models but is yet to be further sparsified and/or undergo further training to recover the accuracy of prediction, inference or creation. The finalized models are sparsified relative to the original models and have been further trained relative to the original models. As set forth above with reference to FIG. 4, there may be multiple versions of finalized models provided with different levels of sparsity. The finalized models have weight tensors that are sparse relative to the original models, and therefore, enables faster processing with lower computing/storage requirements.

Training data 454 is a full data set or a partial data set used for training the original models. The training data 454 may be received from the client along with the original machine learning models. The training data 454 or a part thereof may be accessed by the network network sparsifier 430 to train the intermedial models generated by network sparsifier 430. By doing so, the updated machine learning models that are sparsified relative to the original machine learning models may still generate outputs of accuracy substantially the same as or within a tolerance from that of the original machine learning model.

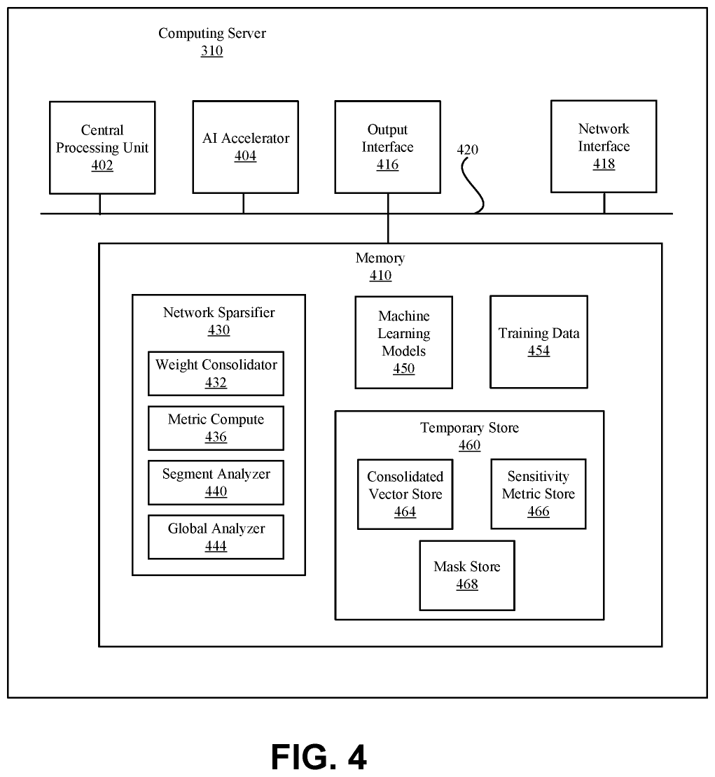

The temporary store 460 is a repository for storing various data associated with the network sparsifier 430. The temporary store 460 may include consolidated vector store 464 for storing consolidated vectors of weights in the models to be sparsified (as described below in detail with FIG. 6), sensitivity metric store 466 for storing an array of sensitivity metric values, and mask store 468 for storing a mask that is applied to weight tensors to sparsify the weight tensors in the machine learning models.

The network sparsifier 430 is a software module or a software module in combination with hardware for processing original machine learning models with dense weight tensors into sparsified machine learning models with sparse weight tensors. In one or more embodiment, the network structure of the original machine learning models (e.g., the number of levels and/or the number of nodes) are retained in the sparsified machine learning models but the weight tensors in the sparsified machine learning models are sparser than those of the original learning models. The network sparsifier 430 may instruct the CPU 402 and/or the AI accelerator 404 to perform various operations associated with sparsifying the machine learning models and improving their performances.

FIG. 5A is a diagram illustrating a two-dimensional dense weight tensor for a layer of an original machine learning model, according to one embodiment. A single small box in FIG. 5A represents a weight, and the tensor has 16×16 weights. FIG. 5B is a diagram illustrating the sparsified version of the weight tensor with a partitioned sparsity. Specifically, in FIG. 5B, small hatched boxes represent weights that are zeroed out and each row of the tensor is a segment (or partition) of 16 weights where 4 weights are zeroed out. Since 4 weights out of 16 weights in the same row are zeroed out, the sparsity is 4/16×100=25%. As described below in detail with reference to FIGS. 6 through 8B, the sparsity of the weight tensors may be partitioned or structured so that a number of sparse weights in a segment of a weight tensor complies with a requirement to leverage hardware capabilities of the CPU 402 or the AI accelerator 404 for executing the machine learning model. In one or more embodiments, the sparse weight tensor may be achieved by applying a mask with some of its entries zeroed out to the dense weight tensor.

The network sparsifier 430 may include, among other software modules, a weight consolidator module 432, a metric compute module 436, a segment analyzer module 440, and a global analyzer module 444. The network sparsifier 430 may include further software modules, and two or more of these software modules may be combined into a single software module.

The weight consolidator module 432 reads weights of multiple layers in the machine learning model under processing and generates a consolidated vector concatenating the weights. FIG. 6 is a conceptual diagram illustrating converting of weights in multiple layers L1 through L (N) of a machine learning model into a consolidated vector by the weight consolidator module 432, according to one embodiment. Each of layers L1 through L (N) represent a weight tensor used in different layers of the machine learning model. The weight consolidator module 432 concatenates or flattens the weights in these layers into a single consolidated vector of a single dimension as shown in FIG. 6 and are stored in the consolidated vector store 464. During the subsequent processes, the consolidated vector is processed and updated instead of the original weights. The use of the consolidated vector is advantageous, among other reasons, because operations across entire weights in machine learning model are made faster by using vectorized operations available on hardware (e.g., CPU or GPU).

The consolidated vector is then analyzed by various other modules of the network sparsifier 430. Although the layers L1 through L (N) are illustrated in FIG. 6 as being of the same rank and shape, in practice, layers L1 through L (N) would have different ranks and shapes.

The metric compute module 436 analyzes the consolidated vector and determines the sensitivity metric values of the weights in the consolidated vector. Then, arrays of sensitivity metric values are generated and populated by the metric compute module 436 for storing in the sensitivity metric store 466. A sensitivity metric value represents the influence that a corresponding weight has on the output of the machine learning model. The arrays of the sensitivity metric values are mapped to the weight tensors. In one or more embodiments, the arrays of sensitivity metric values may formed by updating the consolidated vector so that the weights in the consolidated vector are replaced with the sensitivity metric values. Using the consolidated vector as the array of sensitivity metric values may be advantageous, among other reasons, because the memory space used for sparsifying the machine learning model may be reduced and the same memory location may be referenced for further operations for sparsification of the machine learning model.

The higher the sensitivity metric value, the more impact the corresponding weight has on the output of the machine learning model. Hence, it is preferable to retain weights with higher sensitivity metric values while pruning or zeroing out weights with lower sensitivity metric values. In one or more embodiments, the sensitivity metric value is determined based on the magnitude of the corresponding weight relative to other weights, the gradient of the corresponding weight over time or a combination thereof. For example, a magnitude multiplied by a normalized sum of gradients over a number of training steps may be use as the sensitivity metric value, where the sensitivity metric value is higher when the magnitude and the gradient are higher.

In other embodiments, other factors or equations may be used to compute the sensitivity metric value. When the magnitude of the weights are used as the sensitivity metric values, then the consolidated vector may become the array of sensitivity metric values since no further processing is required to convert the entries in the consolidated vector into the sensitivity metric values.

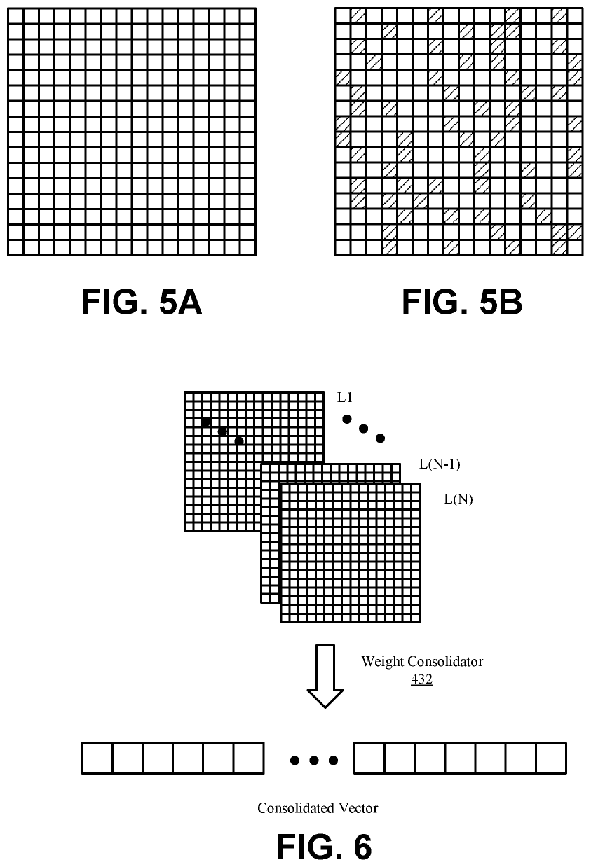

FIG. 7 is a conceptual diagram illustrating processing of segments in the sensitivity metric array by the segment analyzer module 440, according to one embodiment. The segment analyzer module 440 reads a segment of a sensitivity weight array (e.g., a segment corresponding to a row of a weight tensor) and compares the sensitivity metric values in the segment. In one embodiment, a predetermined number (e.g., 4) of the highest sensitivity metric values in the segment are then selected as a result of the comparison. In the example of FIG. 5B, the selected metrics are identified by hatched boxes. In other embodiments, other factors such as adjacency of the sensitivity metric values are considered in selecting the sensitivity metric values for modification. These factors may function as rules or restrictions on sparsifying of corresponding weights so that the hardware of the CPU 402 or the AI accelerator 404 may perform computation associated with the machine learning model in an efficient and expedited manner. A segment may correspond to a part of a layer in the machine learning model and have a predetermined size. For example, in the example of FIG. 7, a segment may correspond to a row of 16 entries in the array of sensitivity metric values of 16×16 sensitivity metric values. After the sensitivity metric values are selected, these values are modified.

The modification to the sensitivity metric values selected from the segment decreases the likelihood that weights corresponding to the sensitivity metric values will be pruned in the subsequent processes of the network sparsifier 430. In one embodiment, the selected sensitivity metric values are modified by adding a predetermined number (e.g., 1e9) to the selected sensitivity metric values.

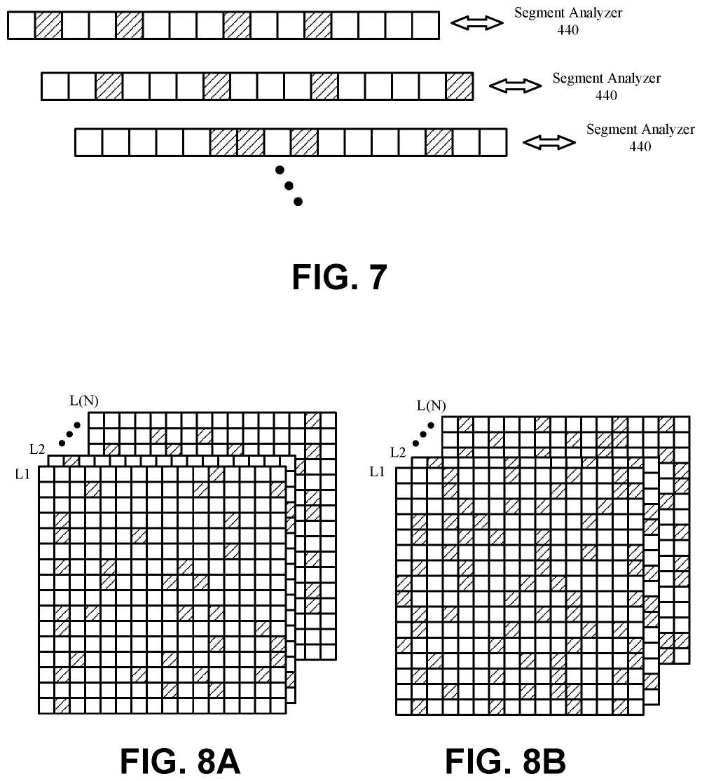

FIGS. 8A and 8B are conceptual diagrams illustrating pruning of weights in layers of a machine learning model by the global analyzer module 444, according to one embodiment. FIG. 8A illustrates layers L1 through L (N) of the machine learning model before processing by the global analyzer module 444 and FIG. 8B illustrates these same layers after pruning by the global analyzer module 444. In both FIGS. 8A and 8B, the hatched boxes represent weights that are zeroed out. The layers L1 through L (N) in FIG. 8B has more hatched boxes than those of FIG. 8A, indicating that the layers processed by the global analyzer module 444 are sparser than the layers before processing by the global analyzer module 444.

The global analyzer module 444 selects the weights in all layers L1 through L (N) with the lowest sensitivity metric values for pruning. In one embodiment, the global analyzer module 444 selects the weights with the lowest sensitivity metric values for pruning. Since a predetermined number of sensitivity metric values in a segment were modified (e.g., by adding a predetermined number), these weights are less likely to be selected for pruning because of their sensitivity metric values are modified to be higher.

The global analyzer module 444 generates or updates a mask indicating which of the weights are to be zeroed out in an intermediate machine learning model, and stores the generated/updated mask in mask store 468. The stored mask is then applied to the weight tensor of the current machine learning model being processed by the network sparsifier 430 to instantiate an intermediate machine learning model. The instantiated intermediate machine learning model may be trained using the training data or its subset, stored in the training data 454. As a result of training the intermediate machine learning model, the weights are updated to recover the accuracy of the inference, prediction or creation operations. The training of the intermediate machine learning model may be performed, for example, using the AI accelerator 404. The updated weights are then used for generating the updated machine learning model which is sparser than the current machine learning model before processing by the network sparsifier 430.

Although FIGS. 8A and 8B illustrate all the layers having the same rank and shape, each of the layers may have different ranks and shapes. Furthermore, instead of selecting the weights to be pruned across all the layers L1 through L (N), the pruning may be performed across a subset of layers with different sparsification targets (e.g., pruning layers L1 to L5 sparsified by 25% whereas layers L6 through LN sparsified by 75%). Furthermore, factors other than the sensitivity metric values may also be considered in selecting the weights to be pruned. For example, if a certain layer is determined to have more influence on the accuracy of the output, a bias may be applied to such layer to prevent or reduce pruning of weights associated with the layer.

The network sparsifier 430 may perform the sparsification in an incremental manner over multiple iterations. For example, the first run of the sparsification may have a target sparsification rate of 5% while the second run of the sparsification rate of 15% and the third run may have the sparsification rate of 25%. Multiple runs of the sparsification may be performed until a target sparsification rate (e.g., 95%) is reached. For each run or iteration, the process of generating a consolidated vector by the weight consolidator module 432, computation of the sensitivity metric values by the metric compute module 436, selection and modification of sensitivity metric values in the sensitivity array by the segment analyzer module 440, pruning of the weights based on the sensitivity metric values by the global analyzer module 444, and training of intermediate machine learning model using an updated mask reflecting the pruned weights may be performed. The training data or its subset used in each iteration or run may be the same or different. In one or more embodiments, the training data used in each iteration or run of training on the intermediate machine learning model is 1 to 3% of the original training data that was used for training the original machine learning model.

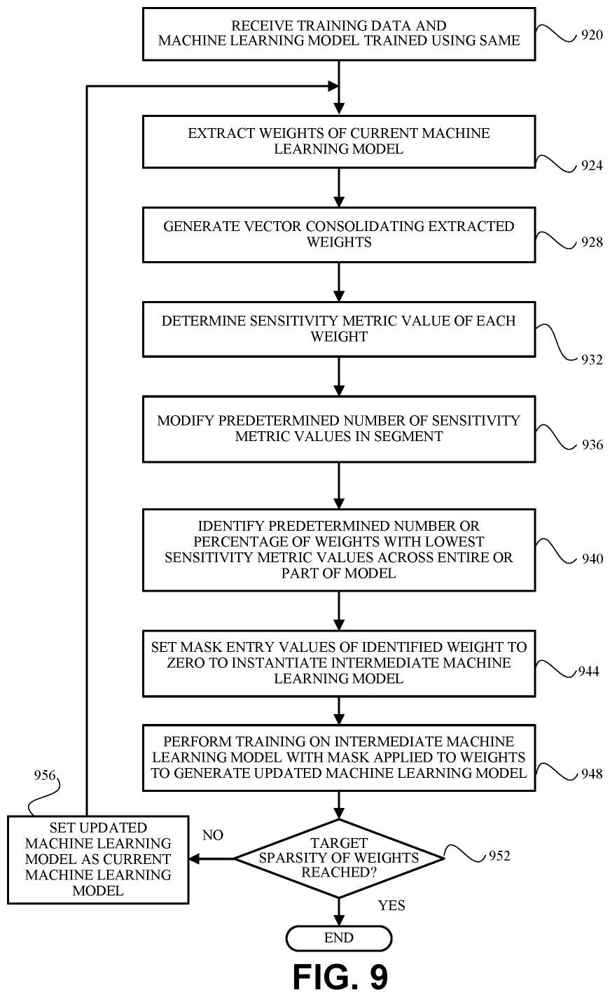

FIG. 9 is a flowchart illustrating the process of sparsifying a machine learning model by the network sparsifier 430, according to one embodiment. The network sparsifier 430 receives 920 training data and the original machine learning model trained using the training data. The received machine learning model and the training data are stored in the machine learning models 450 and the training data 454, respectively. The original machine learning model is then set as the current machine learning model for subsequent processing by the network sparsifier 430.

The weights in multiple layers of the current machine learning model are extracted 924 by the weight consolidator module 432. Then the extracted weights are concatenated into a single vector to generate 928 a consolidated vector. The consolidated vector is then stored in the consolidated vector store 464.

The metric compute module 436 reads the consolidated vector and determines 932 the sensitivity metric values of the weights. The computed sensitivity metric values are then formulated into arrays of sensitivity metric values and are stored in the sensitivity metric store 466. The arrays of the sensitivity metric values may have the same rank, dimensions and shape as the corresponding weight tensors.

The segment analyzer module 440 then reads each segment of the arrays of segments in the sensitivity metric store 466 and modifies 936 a predetermined number of entries of sensitivity metric values (e.g., by adding a predetermined number to the selected entries of sensitivity metric values). The sensitivity metric values for modification may be selected based on factors such as the magnitude of the sensitivity metric values, the gradient of sensitivity metric values, and a combination thereof. Each of the segments is modified, and the arrays of the sensitivity metric values with the modified sensitivity metric values is stored in the sensitivity metric store 466.

The global analyzer module 444 then reads the arrays of the updated sensitivity metric values, and then identifies 940 a predetermined number or percentage of weights with the lowest sensitivity values. A mask is then generated or updated by the global analyzer module 444 to indicate that the selected weights are to be pruned. The mask entry values of the selected weights in the mask are then set 944 to zero.

The generated/updated mask is then applied to the weight tensors of the current machine learning model to generate an intermediate machine learning model. The intermediate machine learning model is then trained 948 to generate the updated machine learning model. The intermediate machine learning model and the updated machine learning model may be stored as the machine learning models 450 in memory 410.

Then it is determined 952 if the updated machine learning model satisfies a termination condition. The termination condition may, for example, indicate that a target sparsity in its weights has been reached. If the target sparsity of weights is reached, then the process at the network sparsifier 430 is terminated. Then the updated machine learning model is deployed for use as a sparsified machine learning model executable on hardware with a higher speed relative to the original machine learning model while producing and output with substantially the same accuracy as the original machine learning model. If it is determined that the target sparsity is not reached, then the updated machine learning model is set 956 as the current machine learning model and the process returns to extracting 942 the weights and repeats the subsequent operations.

The steps and their sequence illustrated in FIG. 9 are merely illustrative. Additional steps may be added or certain steps may be omitted from the process. For example, the step of generating 928 a consolidated vector may be omitted. Further, some of the steps may be performed in a different order or in parallel. For example, extracting 924 of the weights and generating 928 of the consolidated vector may be performed in parallel.

Although above embodiments were described with reference to sparsifying all layers of a machine learning model, only select layers of the machine learning model may be sparsified. The remaining layers may be retained or undergo a different scheme for improving the machine learning model.

Upon reading this disclosure, those of skill in the art will appreciate still additional alternative designs for sparsifying the machine learning models. Thus, while particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A computer-implemented method, comprising:
receiving weights of a plurality of layers of a machine learning model trained using first training data;
determining a sensitivity metric value for each of the weights in the machine learning model, the sensitivity metric value indicating influence of each of the weights on an output of the machine learning model;
for each subset of weights in a layer of the machine learning model, modifying a first predetermined number or percentage of sensitivity metric values;
across the plurality of layers of the machine learning model, selecting a second predetermined number or percentage of the weights as first weights for pruning by comparing the sensitivity metric values of the weights, weights corresponding to the modified sensitivity metric values less likely to be selected as the first weights; and
training the machine learning model with the first weights pruned to generate a first updated machine learning model with a first sparsity of weights.

2. The method of claim 1, further comprising:
determining a sensitivity metric value for each of weights in the first updated machine learning model;
for each subset of weights in a layer of the first updated machine learning model, modifying a second predetermined number or percentage of sensitivity metric values;
across the plurality of layers of the first updated machine learning model, selecting a third predetermined number or percentage the weights of the first updated machine learning model as second weights for pruning by comparing the sensitivity metric values of the weights of the first updated machine learning model, weights of the first updated machine learning model corresponding to the modified sensitivity metric values less likely to be selected for pruning; and
training the first updated machine learning model with the second weights pruned to generate a second updated machine learning model with a second sparsity of weights higher than the first sparsity of weights.

3. The method of claim 2, further comprising:
generating a first mask representing an array with entries corresponding to the weights of the machine learning model;
setting entries of the first mask corresponding to the first weights to zero, where the first mask is applied to the machine learning model for generating the first updated machine learning model;
generating a second mask representing an array with entries corresponding to the weights of the first updated machine learning model; and
setting entries of the second mask corresponding to the second weights to zero, where the second mask is applied to the first updated machine learning model for generating the second updated machine learning model.

4. The method of claim 2, further comprising:
generating a first consolidated tensor concatenating the weights in the machine learning model, the sensitivity metric value of each of the weights in the machine learning model determined by processing the first consolidated tensor; and
generating a second consolidated tensor concatenating the weights in the first updated machine learning model, the sensitivity metric value of each of the weights in the first updated machine learning model determined by processing the second consolidated tensor.

5. The method of claim 2, wherein the training of the machine learning model with the selected weights is performed using second training data that is part of the first training data, and wherein the training of the first updated machine learning model is performed using third training data that is part of the first training data.

6. The method of claim 1, wherein predetermined rules are applied to select the first predetermined number or percentage of the sensitive values, wherein the predetermined rules indicate that sensitivity metric values of higher values are more likely to be modified relative to sensitivity metric values of lower values, and wherein modifying of the first predetermined number or percentage of the sensitivity metric values comprises increasing the first predetermined number or percentage of the sensitivity metric values by a predetermined value.

7. The method of claim 6, wherein the predetermined rules are associated with patterns of weights suitable for accelerated processing by a hardware circuit.

8. The method of claim 1, wherein the sensitivity metric value is based on at least one of a magnitude of each of the weights and a gradient associated with each of the weights.

9. The method of claim 1, further comprising deploying the first updated machine learning model to perform prediction, inference or creation, wherein the first updated machine learning model is faster than the machine learning model.

10. A non-transitory storage medium storing instructions thereon, the instructions when executed by a processor cause the processor to:
receive weights of a plurality of layers of a machine learning model trained using first training data;
determine a sensitivity metric value for each of the weights in the machine learning model, the sensitivity metric value indicating influence of each of the weights on an output of the machine learning model;
for each subset of weights in a layer of the machine learning model, modify a first predetermined number or percentage of sensitivity metric values;
across the plurality of layers of the machine learning model, select a second predetermined number or percentage of the weights as first weights for pruning by comparing the sensitivity metric values of the weights, weights corresponding to the modified sensitivity metric values less likely to be selected as the first weights; and
train the machine learning model with the first weights pruned to generate a first updated machine learning model with a first sparsity of weights.

11. The non-transitory storage medium of claim 10, further storing instructions that cause the processor to:
determine a sensitivity metric value for each of weights in the first updated machine learning model;
for each subset of weights in a layer of the first updated machine learning model, modify a second predetermined number or percentage of sensitivity metric values;
across the plurality of layers of the first updated machine learning model, select a third predetermined number or percentage the weights of the first updated machine learning model as second weights for pruning by comparing the sensitivity metric values of the weights of the first updated machine learning model, weights of the first updated machine learning model corresponding to the modified sensitivity metric values less likely to be selected for pruning; and
train the first updated machine learning model with the second weights pruned to generate a second updated machine learning model with a second sparsity of weights higher than the first sparsity of weights.

12. The non-transitory storage medium of claim 11, further storing instructions that cause the processor to:
generate a first mask representing an array with entries corresponding to the weights of the machine learning model;
set entries of the first mask corresponding to the first weights to zero, where the first mask is applied to the machine learning model for generating the first updated machine learning model;
generate a second mask representing an array with entries corresponding to the weights of the first updated machine learning model; and
set entries of the second mask corresponding to the second weights to zero, where the second mask is applied to the first updated machine learning model for generating the second updated machine learning model.

13. The non-transitory storage medium of claim 11, further storing instructions that cause the processor to:
generate a first consolidated tensor concatenating the weights in the machine learning model, the sensitivity metric value of each of the weights in the machine learning model determined by processing the first consolidated tensor; and
generate a second consolidated tensor concatenating the weights in the first updated machine learning model, the sensitivity metric value of each of the weights in the first updated machine learning model determined by processing the second consolidated tensor.

14. The non-transitory storage medium of claim 11, wherein the instructions to train the machine learning model with the selected weights use second training data that is part of the first training data, and wherein the instructions to train the first updated machine learning model uses third training data that is part of the first training data.

15. The non-transitory storage medium of claim 10, wherein predetermined rules are applied to select the first predetermined number or percentage of the sensitive values, wherein the predetermined rules indicate that sensitivity metric values of higher values are more likely to be modified relative to sensitivity metric values of lower values, and wherein modifying of the first predetermined number or percentage of the sensitivity metric values comprises increasing the first predetermined number or percentage of the sensitivity metric values by a predetermined value.

16. The non-transitory storage medium of claim 15, wherein the predetermined rules are associated with patterns of weights suitable for accelerated processing by a hardware circuit.

17. The non-transitory storage medium of claim 10, wherein the sensitivity metric value is based on at least one of a magnitude of each of the weights and a gradient associated with each of the weights.

18. The non-transitory storage medium of claim 10, further storing instructions that cause the processor to deploy the first updated machine learning model to perform prediction, inference or creation, wherein the first updated machine learning model is faster than the machine learning model.

19. A computer-implemented method, comprising:
(a) receiving weights of a plurality of layers of a current machine learning model trained using first training data;
(b) determining a sensitivity metric value for each of the weights in the current machine learning model, the sensitivity metric value indicating influence of each of the weights on an output of the current machine learning model;
(c) sparsifying the weights of the machine learning model by selectively zeroing the weights with lowest sensitivity metric values to generate an intermediate machine learning model;
(d) training the intermediate machine learning model using second training data to generate an updated machine learning model;
(e) determining if the updated machine learning model satisfies a termination condition;
(f) responsive to determining that the termination condition is satisfied, setting the updated machine learning model as a sparsified machine learning model; and
(g) responsive to determining that the termination condition is not satisfied, setting the updated machine learning model as the current machine learning model and repeating (a) through (g).

20. The method of claim 19, wherein (c) sparsifying the weights comprises:
(c1) for each subset of weights in a layer of the current machine learning model, selecting a first predetermined number or percentage of weights with highest sensitivity metric values;
(c2) increasing sensitivity metric values of the selected weights;
(c3) selecting a second predetermined number of percentage weights in the machine learning model with lowest sensitivity metric values as weights to be pruned; and
(c4) zeroing the weights to be pruned to generate the intermediate machine learning model.

21. A non-transitory computer readable storage medium storing a sparse machine learning model generated by a method comprising:
(a) receiving weights of a plurality of layers of a current machine learning model trained using first training data;
(b) determining a sensitivity metric value for each of the weights in the current machine learning model, the sensitivity metric indicating influence of each of the weights on an output of the current machine learning model;
(c) sparsifying the weights of the machine learning model by selectively zeroing the weights with lowest sensitivity metric values to generate an intermediate machine learning model;
(d) training the intermediate machine learning model using second training data to generate an updated machine learning model;
(e) determining if the updated machine learning model satisfies a termination condition;
(f) responsive to determining that the termination condition is satisfied, setting the updated machine learning model as the sparse machine learning model; and
(g) responsive to determining that the termination condition is not satisfied, setting the updated machine learning model as the current machine learning model and repeating (a) through (g).
